(19) United States
(12) Patent Application Publication
(10) Pub. No.: US 2007/0118361 A1
(43) Pub. Date: May 24, 2007

(54) Window apparatus and method

(76) Inventors: Deepen Sinha, Chatham, NJ (US); Anibal J. S. Ferreira, Sao Mamede Infesta (PT)

Correspondence Address: THE LAW OFFICES OF THOMAS L. ADAMS, 120 EAGLE ROCK AVENUE, P.O. BOX 340, EAST HANOVER, NJ, 07936, US

(21) Appl. No.: 11/544,894

(22) Filed: Oct. 6, 2006

Related U.S. Application Data
(60) Provisional application No. 60/724,850, filed on Oct. 7, 2005.

(51) Int. Cl. G10L 19/14

(52) U.S. Cl. 704/211

(57) ABSTRACT

An envelope for a window function establishes (a) a power complementary condition, and (b) at least a first derivative (or higher order) that is continuous. The window function is developed from samples of the envelope. This discrete window function has a predetermined domain. The window function can be embodied as a windowing device receiving signals from a discrete signal source. This windowing device can adjust values from the discrete signal source according to the window function. A utilization device can use the adjusted values from said windowing device.

### CROSS-REFERENCES TO RELATED APPLICATIONS

This application claims the benefit of U.S. Provisional Patent Application, Ser. No. 60/724,850, filed 7 Oct. 2005, the contents of which are hereby incorporated by reference herein.

### BACKGROUND OF THE INVENTION

1. Field of the Invention

The present invention relates to power complementary windows useful for various types of signal processing.

2. Description of Related Art

Windowing is a prevalent signal processing operation which has important implications to the performance of a range of signal processing algorithms. Several window functions have been proposed and utilized in signal processing. Some examples include Hanning Window, Hamming Window, Kaiser Window, Raised Cosine Window, etc.

In many applications such as well known audio coding schemes like PAC, MP3, AC-3, AAC it is desirable to use a symmetric window function w(n) (with a maximum value of 1.0) that satisfies an additional power complementary condition. To formalize these conditions, a window function of size 2N should be defined. The symmetry condition implies
w(n)=w(2N−n−1), n=0,1, . . , 2N−1 (1)
The power complementary condition is indicated by the constraint
|w(n)|²+|w(n+N)|²=1.0 for n=0,1, . . . , N−1 (2)
The above condition is at times also referred to as Princen-Bradley condition. This condition is herein referred to as the power complementary condition.

In choosing a particular window function the frequency selectivity is an important consideration. The frequency selectivity is characterized by the stop-band energy of the frequency response of the window function. Furthermore, in many applications the time selectivity of the window is also an important consideration. In the framework of power complementary windows, time localization is quantified by the fraction of window energy concentrated in the center half of the window. Obviously the most time localized window is the rectangular window albeit at the cost of extremely poor frequency selectivity. It may also be noted that the popular Raised Cosine window is an example of a power complementary window that has relatively good frequency selectivity but poor time localizing.

In general frequency selectivity and temporal localization are two conflicting requirements and it is difficult to design a window function that has good performance with respect to both of these performance criteria.

Several different criteria have traditionally been used for evaluating the performance of signal processing windows. Some of these are particularly meaningful for the power complementary windows. Listed below are a few of the most pertinent performance criteria.

Time Domain Localization and Aliasing

Time domain localization can be measured with the help of a criterion based on its energy concentration in the center half. A converse temporal spread criterion (TDS) based on the energy concentration outside the center band is defined as below.

$$TDS = \frac{1 - {\sum }_{n = N / 2}^{3 N / 2 - 1} {w}^{2} ( n )}{{\sum }_{n} {w}^{2} ( n )} \qquad ( 3 )$$

A lower value for TDS (measured in dB) is desirable. As described in the next section a prominent area of application for power complementary windows is in the area of perfect reconstruction Modulated Lapped Transforms which employ 50% overlap between consecutive analysis frames. These filter banks utilize the so-called Time Domain Alias mechanism. Estimation of un-cancelled TDAC energy in the absence of the overlap-add alias cancellation operation is an important consideration. This is directly tied to the TDS criterion defined above.

Stop-Band Energy

The Frequency selectivity of Window may be measured with the help of its stop band energy. A stop band edge frequency f_{c} may be chosen as f_{c}=k.(π/N) (where k is an integer).

$$SBE = {\int }_{f \geq {f}_{c}}^{π} {\vert W ( f ) \vert}^{2} ⅆ f \\ ( unweighted ) \qquad ( 4 )$$

where W(f) is the frequency response of the window. This value is also expressed in dB and a higher negative value indicates better frequency selectivity. For smaller values of k this measure is dominated by the so-called Near Field Response (i.e., energy of the first few side-lobes). For higher values of k this measure represents the Far Field Response (or Far Field Rejection) of the windows. In the above definition SBE is defined in an un-weighted form. A weighted definition of Stop Band Energy is as follows

$$SBE = {\int }_{f \geq {f}_{c}}^{π} α ( f ) {\vert W ( f ) \vert}^{2} ⅆ f \\ ( weighted ) \qquad ( 5 )$$

The weight function α(f) for example may be used to weight the frequency bands farther away from the center frequency more strongly.

Main Lobe Spectral Response

Spectral interval between Peak Gain and the −3.0 dB and/or −6.0 dB response level measures the width of the main lobe. The main lobe width, for example, affects the coding gain of a transform using a particular window function.

Relative Strength of First and Second Side Lobes

The strength of first and second side lobes in relation to the spectral peak is also an interesting performance metric for many applications.

Scalloping Loss

Scalloping Loss (SL) is defined as below is sometimes a useful measure in evaluating the performance of a window function. It is defined as the ratio of the gain of a tone located at the offset of half frequency bin (for frequency bins in DFT analysis) with respect to the gain of the tone located at the center of the bin.

$$SL = \frac{\vert {\sum }_{n} w ( n ) {ⅇ}^{j \frac{π}{2 N}} \vert}{{\sum }_{n} w ( n )} \qquad ( 6 )$$

Power Complementary Windows

Several power complementary windows have been reported in the literature. A commonly used window is the Sine (or Raised Cosine) window defined as:

$${w}_{k} = sin [ \frac{π}{2 N} ( k + \frac{1}{2} ) ] \qquad ( 7 )$$

It may be noted that this window is identical to a smooth window with a degree p=1. (i.e., it possesses no continuous differential). Another such window is the one used in Vorbis audio coding scheme. The Vorbis window is defined as:

$$w ( n ) = sin [ \frac{π}{2} {sin}^{2} ( \frac{π}{2 N} ( k + \frac{1}{2} ) ) ] \qquad ( 8 )$$

In addition the AC-3 audio codec (as well as AAC audio codec) uses a so-called “Dolby Window” which is also referred to as Kaiser-Bessel Derived Window (KBD) and is based on the integration of a Kaiser-Bessel function. For present purposes, unless indicated otherwise, reference to the Dolby window will mean the Dolby window with α=3.0.

Furthermore, many researchers have proposed the utilization of optimized window functions, which are designed by solving a constraint optimization problem that minimizes a cost function (e.g., one based on Time Domain Aliasing and Stop Band Energy). The optimization may be performed using a non linear optimization technique which is part of MATLAB computing platform. One such optimized window (“AJF Optimum Window”) is reported in Anibal J. S. Ferreira, Convolutional Effects in Transform Coding with TDAC: An Optimal Window, IEEE Transactions on Speech and Audio Processing, vol. 4, n° 2, pp. 104-114, March 1996.

### SUMMARY OF THE INVENTION

In accordance with the illustrative embodiments demonstrating features and advantages of the present invention, there is provided a discrete window function having a predetermined domain. The method includes the step of selecting an envelope for the window function to establish for it (a) a power complementary condition, and (b) at least a first derivative (or a higher order derivative) that is continuous. The method also includes the step of producing the window function from samples of the envelope.

In accordance with another aspect of the present invention, there is provided apparatus for establishing a discrete window function having a predetermined domain. The apparatus has a discrete signal source and a windowing device. This device can adjust values from the discrete signal source according to a window function having an envelope that establishes: (a) a power complementary condition, and (b) at least a first derivative (or a higher order derivative) that is continuous. The apparatus also includes a utilization device for using adjusted values from said windowing device.

Systems employing the foregoing principles represent a new family of smooth power complementary windows which exhibit a high level of localization in both time and frequency domain. This window family is parameterized by a “smoothness quotient” (also called the “order” of the window). As the smoothness quotient increases the window becomes increasingly localized in time (most of the energy gets concentrated in the center half of the window) and frequency (far field rejection becomes increasing stronger to the order of 150 dB or higher). A closed form solution for such window function exists and the associated design procedure is described.

This new class of windows is quite attractive for a number of applications as switching functions, equalization functions, or as windows for overlap-add and modulated filter banks used in applications such as audio coding. An extension to the family of smooth windows which exhibits improved near-field response in the frequency domain is also discussed.

### BRIEF DESCRIPTION OF THE DRAWINGS

The above brief description as well as other objects, features and advantages of the present invention will be more fully appreciated by reference to the following detailed description of illustrative embodiments in accordance with the present invention when taken in conjunction with the accompanying drawings, wherein:

FIG. 1 graphically illustrates the shape of windows of three different orders in accordance with principles of the present invention;

FIG. 2 graphically illustrates the frequency response of an order 1 window;

FIG. 3 graphically illustrates the frequency response of an order 2 window;

FIG. 3 graphically illustrates the frequency response of an order 3 window;

FIG. 5 graphically illustrates the 2^{nd} order smooth window compared to the Dolby window;

FIG. 6 graphically illustrates the spectrum of the 2^{nd} order smooth window compared to the Dolby window;

FIG. 7 graphically illustrates the near field spectrum of the 2^{nd} order smooth window compared to the Dolby;

FIG. 8 graphically illustrates the shape of the 3rd order smooth window compared to the Dolby window;

FIG. 9 graphically illustrates the spectrum of the 3rd order smooth window compared to the Dolby window;

FIG. 10 graphically illustrates a near field spectrum of the 3rd order smooth window compared to the Dolby window; and

FIG. 10 is a block diagram showing a codec employing the present window.

### DETAILED DESCRIPTION OF THE PREFERRED EMBODIMENTS

The new class of windows disclosed herein is designed using the realization that the power complementary condition (2) is a time domain dual of an identical frequency domain condition used in the design of wavelets with high degree of regularity. See e.g., I. Daubechies, “Orthonormal bases of compactly supported wavelets,” Commun. Pure Appl. Math., vol. 41, pp. 909-996, 1988. This leads to a systematic design procedure for a family of smooth windows parameterized by a smoothness quotient. The window family is unique in the sense that as the smoothness quotient is increased the window becomes better localized in both time and frequency domain.

This specification incorporates by reference the following paper by the inventors: Deepen Sinha and Anibal Ferreira “A New Class of Smooth Power Complementary Windows and their Application to Audio Signal Processing,” 119th Convention of the Audio Engineering Society, October 2005.

It is well known in the theory of signal approximation and splines that the smoothness of a function increases as a function of the highest order continuous differential it possesses. The increased smoothness of a function results in improved frequency response for the function. The present approach is to construct the proposed family of smooth window based on such differentiability criterion. In particular the window function w(n) is constructed as samples of a continuous function w(t) with compact support, in other words

$$w ( t ) = 0 ∀ t ∉ [ 0 , 1 ] \\ and \\ w ( n ) = w ( t ) {\vert}_{t = \frac{i + 0.5}{2 N}} , i = 0 , 1 , … , 2 N - 1 \qquad ( 9 )$$

The window is said to be smooth to a degree p (also called the order of the smooth window) if it possesses a continuous differential of order p−1. Accordingly, a procedure is described herein for constructing a power complementary window with an arbitrary degree of smoothness, p. As will be seen below, higher degree of smoothness for a window function (satisfying the power complementary condition) results in improved temporal localization (in addition to improved far-field frequency response).

To describe the design procedure we first define a function P₀(ζ)which may be considered as a complex periodic extension of w(t) with conjugate symmetry; i.e.,

$${P}_{0} ( - ξ ) = {P}_{0}^{*} ( ξ ) \\ {P}_{0} ( ξ + 2 π ) = {P}_{0} ( ξ ) \\ and \\ w ( t ) = {\vert {P}_{0} ( ξ ) \vert}_{ξ = π ( 2 t - 1 )} ∀ t ∈ [ 0 , 1 ] \qquad ( 10 )$$

The power symmetry condition in (2) puts the following constraint on P₀(ζ); i.e.,
|P₀(ζ)|²+|P₀(ζ+π)|²=1 (11)
And smoothness quotients, translates into the condition that P₀(ζ) has a zero order p at ζ=π. Readers familiar with the theory of wavelets and filter banks will readily recognize that the above formulation makes this family of windows the time domain dual of the well known orthogonal wavelet filter bank used in 2 band QMF analysis that satisfy a regularity or flatness constraint. A solution for P₀(δ)that satisfies (10) can be found using a famous result due to Daubechies (paper noted supra). In particular we reproduce Proposition 4.5 from this reference as follows:
Proposition [Daubechies, 1988]:
Any Trigonometric polynomial solution of equation (10) above is of the form

$${P}_{0} ( ξ ) = {[ \frac{1}{2} ( 1 + {ⅇ}^{j ξ} ) ]}^{p} Q ( {ⅇ}^{j ξ} ) \qquad ( 12 )$$

where p≧1 is the order of zeros it possesses at ζ=π and Q is a polynomial such that

$${\vert Q ( {ⅇ}^{j ξ} ) \vert}^{2} = {\sum }_{k - 0}^{p - 1} ( \begin{matrix}N - 1 + k \\ k\end{matrix} ) {sin}^{2 k} \frac{1}{2} ξ + [ {sin}^{2 N} \frac{1}{2} ξ ] R ( \frac{1}{2} cos ξ ) \qquad ( 13 )$$

where R is an odd polynomial. In the above

$$( \begin{matrix}n \\ k\end{matrix} )$$

implies the Choice function.
See Alexander D. Poularikas, The Handbook of Formulas and Tables for Signal Processing, CRC Press, 1999. The polynomial R is not arbitrary, and for present purposes (as will be explained below) may be set to zero.

A solution for P₀(ζ) may be found by using spectral factorization technique on the polynomial, Q(e^{jζ}). For this we substitute

$$sin \frac{1}{2} ξ = \frac{{z}^{\frac{1}{2}} - {z}^{- \frac{1}{2}}}{2} \qquad ( 14 )$$

where z is a free complex variable. As a result:

$${\vert Q ( z ) \vert}^{2} = {\sum }_{k - 0}^{p - 1} ( \begin{matrix}N - 1 + k \\ k\end{matrix} ) \frac{{[ z - 2 + {z}^{- 1} ]}^{k}}{{4}^{k}} \qquad ( 15 )$$

The procedure for constructing the smooth power complementary window of an order p is as follows:
Step 1:
For the chosen p form the polynomial |Q(Z)|² as in (13) above.
Step 2:
Find all the roots of |Q(Z)|². It may be noted that all the roots will occur in complex conjugate pairs which are also mirror imaged across the unit circle, in other words if z=pe^{jφ} is a root then so will be

$$z = {ρⅇ}^{- j ϕ} , \frac{1}{ρ} {ⅇ}^{j ϕ} , and \frac{1}{ρ} {ⅇ}^{- j ϕ}$$

(this results from the fact that |Q(z)|² is a zero phase, real polynomial).
Step 3:
For each set of roots choose one pair which is on the same side of the unit circle. Form a polynomial Q̅(z)by combining all the chosen roots. We have | Q̅(z)|=|Q(z)| (this is spectral factorization).
Step 4:
Combine Q̅(z) with the p^{th} order zero in (12) to form one possible polynomial, P₀(z). The taps of this P₀(z) form a FIR filter p(n).
Step 5:
P₀(z)can be found by performing a Fourier analysis of the sequence p(n). The window coefficients are then computed by sampling the Fourier transform of p(n) as per equations (9) and (10).

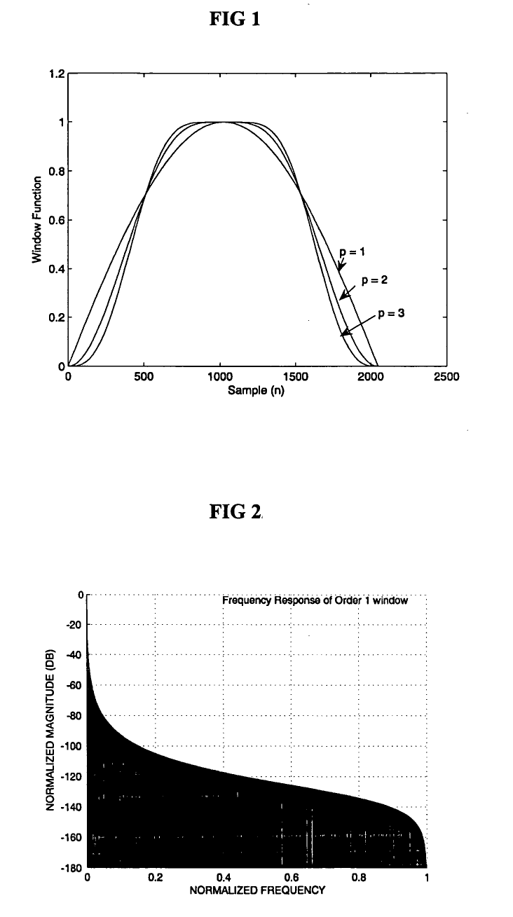

Windows designed using the procedure for p=1,2,3 are shown in FIG. 1. FIG. 1 gives examples of smooth windows of various order, specifically, three windows of size 2048 samples and order respectively of p=1, p=2, and, p=3. The magnitude response of these windows is included in FIG. 2, 3 and 4, respectively. It is readily apparent that as p is increased the windows become more localized in time and at the same time the far field frequency responses improve substantially. Note that for the order 1 window for which magnitude response is shown in FIG. 2 (p=1), this window is identical to the Raised Cosine (Sine) window (see discussion of raised cosine window above)

A couple of comments about the above procedure are in order. Firstly, it may be noted that although spectral factorization may yield several different choices for Q̅(z) all these result in identical magnitude response for P₀(z)and hence the same window function. Furthermore, the choice of R=0 in equation (13) is justified because inclusion of this will increase the order of p(n) thus adversely affecting the frequency response of the window without adding to the temporal localization of the window.

Table I summarizes several figures of merit for various power complementary window functions. (AJF refers to the AJF Optimum Window discussed that the end of Background section of this specification.) The following conclusions may be drawn:

It is obvious that the higher order smooth windows (last three columns under “Inventive Window”) provide substantially better temporal localization (lower TDS) and Frequency Selectivity (Lower SBE, particularly in the Far Field Response) in comparison to the Raised Cosine (Sine) window at the cost of a slight increase in the main lobe width.

As the order of the smooth window is increased there is a very substantial improvement in Far Field Response (k 5) and temporal localization (TDS). This gain comes at the cost of somewhat lower Near Field rejection.

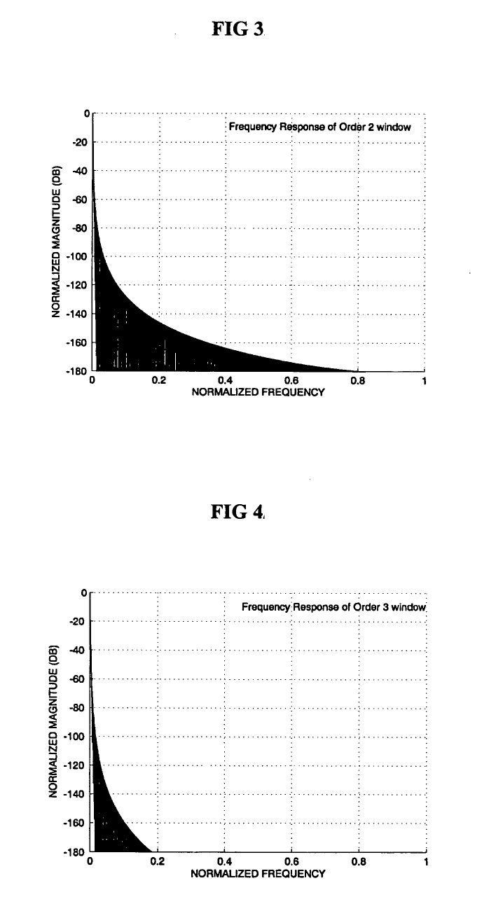

Many performance metrics of 2^{nd} order smooth window match closely with the Dolby Window and Vorbis Window. The Far Field rejection however is substantially better. This is not apparent from the data in Table I, but is readily apparent in FIG. 3(b), where the frequency response of this window is compared to the Dolby window.

TABLE 1

| | Sine - | | | | | | |
|---|---|---|---|---|---|---|---|
| Performance | Raised | Dolby | | AJF | Inventive Window | | |
| Metric | Cosine | (alpha = 3) | Vorbis | (Opt.) | p = 2 | P = 3 | P = 3 |
| Main Lobe Width | 0.018 | 0.02 | 0.02 | 0.019 | 0.02 | 0.02 | 0.02 |
| (−6.0 dB, | | | | | | | |
| normalized freq.) | | | | | | | |
| TSD (dB) | −15 | −18 | −18 | −17 | −18 | −20 | −21 |
| SBE(dB) | −22 | −23 | −22 | −23 | −22 | −21 | −18 |
| (Unweighted) | | | | | | | |
| f_{c} = 2 · (π/N) | | | | | | | |
| SBE(dB) | −25 | −38 | −37 | −32 | −37 | −36 | −31 |
| Unweighted | | | | | | | |
| f_{c} = 3 · (π/N) | | | | | | | |
| SBE(dB) | −27 | −43 | −42 | −34 | −40 | −44 | −38 |
| (Unweighted | | | | | | | |
| f_{c} = 4 · (π/N) | | | | | | | |
| SBE(dB) | −29 | −44 | −44 | −36 | −44 | −53 | −57 |
| (Unweighted) | | | | | | | |
| f_{c} = 5 · (π/N) | | | | | | | |
| SL (dB) | −1.1 | −0.85 | −0.8 | −0.9 | −0.85 | −0.8 | −0.8 |
| 1st Side Lobe(dB) | −23 | −21 | −20 | −22 | −21 | −19 | −18 |
| 3rd Side Lobe(dB) | −36 | −56 | −47 | −44 | −44 | −57 | −56 |
| 5th Side Lobe(dB) | −43 | −61 | −56 | −48 | −55 | −68 | −69 |

The 3^{rd} order smooth window represents a good compromise with very high temporal localization and far field rejection with only a small penalty in terms of first few side lobe heights.

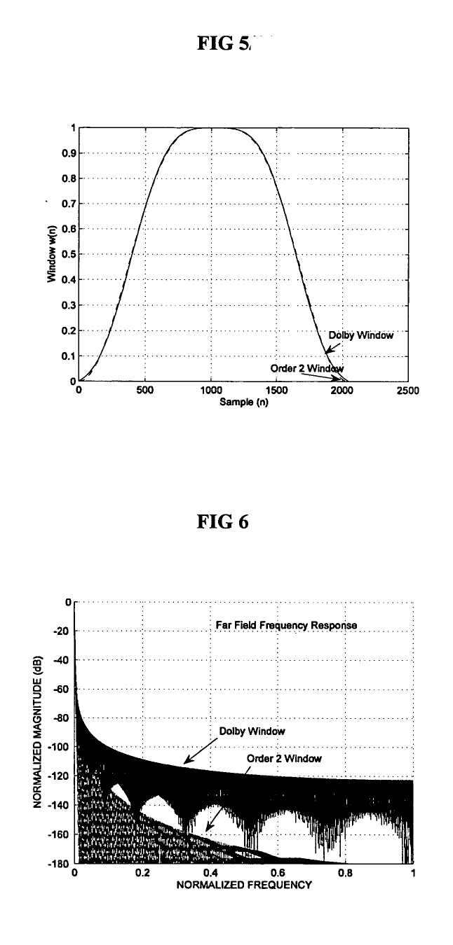

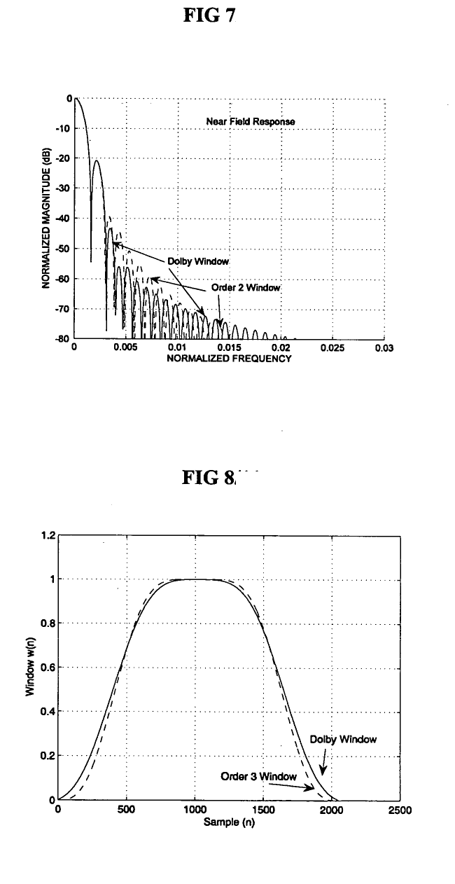

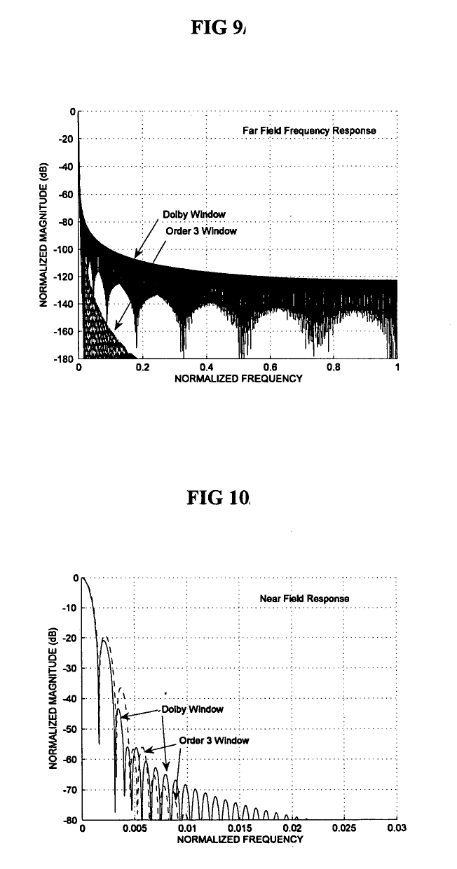

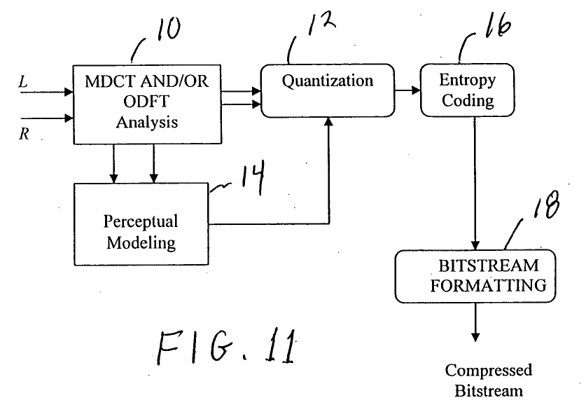

A direct comparison of 2^{nd} and 3^{rd} order smooth windows is presented in FIGS. 5-7 and FIGS. 8-10, respectively. The windows shapes are shown in FIG. 5 (2^{nd} order with Dolby window) and FIG. 8 (3^{rd} order with Dolby window). The corresponding full spectrum plot (highlighting the far field rejection) is shown in FIG. 6 and FIG. 9. A closer comparative look at the Near Field responses of the 2^{nd} and 3^{rd} order smooth windows is shown in FIG. 7 and FIG. 10 respectively.

The proposed family of smooth windows is optimal in the sense of being maximally flat. The term maximally flat is often used in the context of filter/filter bank design and refers to the closeness of the filter magnitude response to an ideal rectangular function. The time domain duality of the smooth windows indicates similar characteristics for these windows in time domain. In other words it can be shown that for a fixed cost a smooth window of an appropriate order is closest to the rectangular window in time domain. The cost in this case is in the form of main lobe width and near field frequency selectivity. The maximal flatness of the window function comes from requiring that the window posses a continuous differential (hence a vanishing differential) at the edges. The flatness at the edges leads to flatness at the center of the window due to the power complementary condition.

Also as noted earlier, another very interesting aspect of the smooth window family is that as the order (p) is increased the window approaches the rectangular window in time domain at the same time its far field frequency selectivity improves substantially.

### Applications of the Invention Windows

The lapped MDCT transform is quite popular in audio compression algorithms. In MDCT a real sequence of length 2N,x(n), is transformed into a real sequence of length N, f(k), as

$$f ( k ) = {\sum }_{n} w ( n ) \cdot x ( n ) \cdot cos [ \frac{π}{N} ( k + \frac{1}{2} ) ( n + \frac{1}{2} + \frac{N}{2} ) ] \qquad ( 16 )$$

The MDCT filter bank- utilizes the symmetry of cosine basis function to achieve perfect reconstruction. This mechanism is often referred to as Time Domain Alias Cancellation (TDAC). The frequency selectivity of the windows plays an important role in the coding gain of the transform as well as the cleanliness of harmonic reconstruction in a signal rich in harmonics. Also lower TDS is important to control the temporal spread of quantization noise and un-cancelled time domain alias terms. A smooth window of order p=2 or 3 was found to improve the performance of audio codecs significantly.

Referring to FIG. 11, the illustrated audio codec uses the presently disclosed smooth window for spectrum analysis. In block 10 the MDCT transform is performed on sampled values of the right and left stereo channel L and R (herein referred to as a discrete signal source) according to equation (16), where w(n) is the novel inventive window function, operating as a windowing device. The ODFT transform will be similar and will use the same window. In a conventional manner these transform coefficients are quantized in block 12, which is referred to herein as a utilization device. In a well-known manner, the size of the quantizing step can be adjusted by the psychoacoustic model performed in block 14. For example, a masking function can be assigned to relatively large, dominant components which can then attenuate neighboring components by increasing the size of the quantizing step in block 12. Thereafter, entropy coding may be reformed in block 16 using for example Huffman coding. A formatted bitstream is then assembled in block 18 to transmit the compressed audio information.

Other applications are contemplated for the window function besides audio codecs. For example, use of a cross fade or switching function is prevalent in audio processing, music synthesis and other audio applications. A power complementary cross fade has the advantage that it preserves the instantaneous energy when making the transition. Use of the presently disclosed, higher order smooth windows (rather than a raised cosine function) allows for a more rapid transition that is still smooth and low in frequency smearing. This is the direct result of improved time frequency localization of the smooth windows.

The present smooth window will also find application as a transition function for multi-band adaptive processing (inter-band transition). Since windowing in frequency domain is equivalent to convolution in time the superior far field response of the higher order smooth windows results in lower temporal ringing due to frequency domain processing (particularly when high frequency resolution analysis is used.

In still another application, the present window may be used in DFT analysis with overlapping blocks. The advantage of using overlapping blocks is that discontinuities at the boundary are avoided and better frequency selectivity is achieved. However, because of the overlap, the effect of processing in a single block is spread over adjacent blocks. By using the present higher order smooth windows one is able to localize the effects better in time while preserving the advantages of overlap operation.

### Extension to the Invention Window Family

As noted above the improved time and frequency (far field) selectivity of the smooth window family is at times associated with a slight (or significant for higher orders) increase in the first few side lobes of the frequency spectrum. In some applications improvement in temporal and far field rejection beyond a certain point is not of particular use but rather a better near field response is desirable. In these applications a mechanism that allows for the trade-off of some of the localization gains for an improved near field response is desirable. This can be accomplished using a set of windows derived from a smooth window of an appropriate order.

Accordingly, a novel family of smooth power complementary windows is described, as well as a constructive procedure for generating a smooth window with any desired degree of smoothness. Depending upon the application, and its associated time and frequency selectivity requirement, a window of desired order can be generated and employed. The smooth windows have utility in a variety of signal processing applications such as audio coding, processing, analysis, equalization, music synthesis, etc.

Obviously, many modifications and variations of the present invention are possible in light of the above teachings. It is therefore to be understood that within the scope of the appended claims, the invention may be practiced otherwise than as specifically described.

1. A method for establishing a discrete window function having a predetermined domain, the method comprising the steps of:
selecting an envelope for the window function to establish for it:
(a) a power complementary condition, and
(b) a first derivative that is continuous; and
producing the window function from samples of the envelope.

2. A method according to claim 1 wherein the first n derivatives of said envelope are continuous, n being at least two.

3. A method according to claim 1 wherein the envelope of the window function is selected to correspond to the absolute value of the following function whose real variable ζ is evaluated over a domain of length 2n:
Q(e^{j ζ}) [½(1+e^{j ζ})]^{p} where Q is a polynomial such that
$${\vert Q ( {ⅇ}^{j ξ} ) \vert}^{2} = {\sum }_{k = 0}^{p - 1} ( \begin{matrix}N - 1 + k \\ k\end{matrix} ) {sin}^{2 k} ξ / 2$$

4. A method according to claim 2 wherein n is chosen to adjust temporal localization.

5. A method according to claim 2 wherein n is chosen to adjust far field response.

6. A method according to claim 2 wherein n is chosen to adjust side lobe height.

7. A method according to claim 1 comprising the step of:
employing said envelope to perform a transform between a time domain and frequency domain.

8. A method according to claim 1 comprising the step of:
employing said envelope to perform a transform using one of MDCT or DFT.

9. A method according to claim 1 comprising the step of:
employing said envelope to perform a cross fade or switching function.

10. Apparatus for establishing a discrete window function having a predetermined domain, comprising:
a discrete signal source;
a windowing device for adjusting values from said discrete signal source according to a window function having an envelope that establishes:
(a) a power complementary condition, and
(b) a first derivative that is continuous; and
utilization device for using adjusted values from said windowing device.

11. Apparatus according to claim 11 wherein the first n derivatives of said envelope are continuous, n being at least two.

12. Apparatus according to claim 11 wherein the envelope of the window function is selected to correspond to the absolute value of the following function whose real variable ζ is evaluated over a domain of length 2n:
Q(e^{j ζ}) [½(1+e^{j ζ})]^{p} where Q is a polynomial such that
$${\vert Q ( {ⅇ}^{jξ} ) \vert}^{2} = {\sum }_{k = 0}^{p - 1} ( \begin{matrix}N - 1 + k \\ k\end{matrix} ) {sin}^{2 k} ξ / 2$$

13. Apparatus according to claim 12 wherein n is chosen to satisfy a predetermined temporal localization requirement.

14. Apparatus according to claim 12 wherein n is chosen to satisfy a predetermined far field response requirement.

15. Apparatus according to claim 12 wherein n is chosen to satisfy a predetermined side lobe height requirement.

16. Apparatus according to claim 11 wherein said utilization device performs a transform between a time domain and frequency domain.

17. Apparatus according to claim 11 wherein said utilization device performs a transform using one of MDCT or DFT.

18. Apparatus according to claim 11 wherein said utilization device performs a cross fade or switching function.
